(19) United States
(12) Patent Application Publication
(10) Pub. No.: US 2008/0212235 A1
(43) Pub. Date: Sep. 4, 2008

(54) DATA RECORDING SLIDER HAVING AN AIR BEARING SURFACE PROVIDING HIGH PRESSURE RELIEF FOR VIBRATION DAMPING

(75) Inventors: Walton Fong, San Jose, CA (US); Donald Ray Gillis, San Jose, CA (US); Remmelt Pit, Cupertino, CA (US); Mike Suk, Palo Alto, CA (US)

Correspondence Address: ZILKA-KOTAB, PC- HIT, P.O. BOX 721120, SAN JOSE, CA, 95172-1120, US

(73) Assignee: HITACHI GLOBAL STORAGE TECHNOLOGIES

(21) Appl. No.: 11/681,116

(22) Filed: Mar. 1, 2007

(51) Int. Cl. G11B 5/596

(52) U.S. Cl. 360/236.5

(57) ABSTRACT

A slider for magnetic data recording. The slider has an air bearing surface with a trailing edge pad that is configured with a series of recesses that damp slider oscillations during use. The series of recesses formed in the trailing pad of the slider reduce slider oscillations by creating localized pressure gradients within the generally high pressure area over the pad. The slider can be configured with a raised primary pad and a secondary raised pad formed on the primary raised pad. A series of recesses formed in the secondary pad prevent slider oscillations, which would otherwise be especially problematic in a slider having such a secondary raised pad and associated higher pressure area thereover.

### FIELD OF THE INVENTION

The present invention relates to magnetic data recording, and more particularly to a slider having an air bearing surface design for damping slider oscillations during flight over a magnetic disk.

### BACKGROUND OF THE INVENTION

The heart of a computer's long term memory is an assembly that is referred to as a magnetic disk drive. The magnetic disk drive includes a rotating magnetic disk, write and read heads that are suspended by a suspension arm adjacent to a surface of the rotating magnetic disk and an actuator that swings the suspension arm to place the read and write heads over selected circular tracks on the rotating disk. The read and write heads are directly located on a slider that has an air bearing surface (ABS). The suspension arm biases the slider toward the surface of the disk, and when the disk rotates, air adjacent to the disk moves along with the surface of the disk. The slider flies over the surface of the disk on a cushion of this moving air. When the slider rides on the air bearing, the write and read heads are employed for writing magnetic transitions to and reading magnetic transitions from the rotating disk. The read and write heads are connected to processing circuitry that operates according to a computer program to implement the writing and reading functions.

The write head has traditionally included a coil layer embedded in first, second and third insulation layers (insulation stack), the insulation stack being sandwiched between first and second pole piece layers. A gap is formed between the first and second pole piece layers by a gap layer at an air bearing surface (ABS) of the write head and the pole piece layers are connected at a back gap. Current conducted to the coil layer induces a magnetic flux in the pole pieces which causes a magnetic field to fringe out at a write gap at the ABS for the purpose of writing the aforementioned magnetic transitions in tracks on the moving media, such as in circular tracks on the aforementioned rotating disk.

In recent read head designs a spin valve sensor, also referred to as a giant magnetoresistive (GMR) sensor, has been employed for sensing magnetic fields from the rotating magnetic disk. The sensor include a nonmagnetic conductive layer, referred to as a spacer layer, sandwiched between first and second ferromagnetic layers, referred to as a pinned layer and a free layer. First and second leads are connected to the spin valve sensor for conducting a sense current therethrough. The magnetization of the pinned layer is pinned perpendicular to the air bearing surface (ABS) and the magnetic moment of the free layer is located parallel to the ABS, but free to rotate in response to external magnetic fields. The magnetization of the pinned layer is typically pinned by exchange coupling with an antiferromagnetic layer.

The thickness of the spacer layer is chosen to be less than the mean free path of conduction electrons through the sensor. When this arrangement, a portion of the conduction electrons is scattered by the interfaces of the spacer layer with each of the pinned and free layers. When the magnetizations of the pinned and free layers are parallel with respect to one another, scattering is minimal and when the magnetization of the pinned and free layer are antiparallel, scattering is maximized. Changes in scattering alter the resistance of the spin valve sensor in proportion to cosθ, where θ is the angle between the magnetizations of the pinned and free layers. In a read mode the resistance of the spin valve sensor changes proportionally to the magnitudes of the magnetic fields from the rotating disk. When a sense current is conducted through the spin valve sensor, resistance changes cause potential changes that are detected and processed as playback signals.

In order to maximize the magnetic performance of a data recording system, it is necessary to minimize the fly height of a slider over a disk. Minimizing the fly height of the slider allows the read sensor and write head to be as close as possible to the magnetic medium. Current and future magnetic recording systems, therefore, have fly heights that are extremely small. One problem presented by such extremely small fly heights is that oscillations or vibrations can occur when the slider is disturbed, such that the slider begins to modulate or “bounce” over the disk. Large oscillatory motion of the slider, therefore, may result in contact between the magnetic read/write head and the disk surface. This catastrophic contact can result in significant data loss, and even permanent damage to the disk and to the read/write head.

Therefore, there is a strong felt need for a data recording system design that can allow very small fly heights while also preventing oscillatory motion of the slider over the disk. Such a design would preferably achieve these goals with minimal additional manufacturing or design complexity or cost.

### SUMMARY OF THE INVENTION

The present invention provide a slider for magnetic data recording. The slider has an air bearing surface with a trailing edge pad that is configured with a series of recesses that damp slider oscillation during use. The series of recesses formed in the trailing pad of the slider reduce slider oscillations by creating localized pressure gradients within the generally high pressure area over the pad.

The slider can be configured with a raised primary pad and a secondary raised pad formed on the primary raised pad. A series of recesses formed in the secondary pad prevent slider oscillations, which would otherwise be especially problematic in a slider having such a secondary raised pad and associated higher pressure area thereover.

The recesses formed in the ABS can be of many different configurations. For example, the recesses can be discrete shapes such as squares, circles, triangles or irregular shapes. The recesses can also be configured as a series of trenches, which can be straight or curved and could be irregular, serpentine, or could be arranged in a random or interlocking manner such as a labyrinth structure.

These and other features and advantages of the invention will be apparent upon reading of the following detailed description of preferred embodiments taken in conjunction with the Figures in which like reference numerals indicate like elements throughout.

### BRIEF DESCRIPTION OF THE DRAWINGS

For a fuller understanding of the nature and advantages of this invention, as well as the preferred mode of use, reference should be made to the following detailed description read in conjunction with the accompanying drawings which are not to scale.

FIG. 1 is a schematic illustration of a disk drive system in which the invention might be embodied;

FIG. 2 is an ABS view of a slider, taken from line 2-2 of FIG. 1, illustrating the location of a magnetic head thereon;

FIG. 3 is a cross sectional view view, taken from line 3-3 of FIG. 2 and rotated 90 degrees counterclockwise, of a magnetic head according to an embodiment of the present invention;

FIG. 4 is an enlarged ABS view of a trailing end of a slider according to a possible embodiment of the invention;

FIG. 5 is an enlarged ABS view of the trailing end of a slider according to another embodiment of the invention;

FIG. 6 is an enlarged ABS view of the trailing end of a slider according to yet another embodiment of the invention; and

FIG. 7 is a side cross sectional view of the trailing end of the slider as taken from line 7-7 of FIG. 6.

### DETAILED DESCRIPTION OF THE EMBODIMENTS

The following description is of the best embodiments presently contemplated for carrying out this invention. This description is made for the purpose of illustrating the general principles of this invention and is not meant to limit the inventive concepts claimed herein.

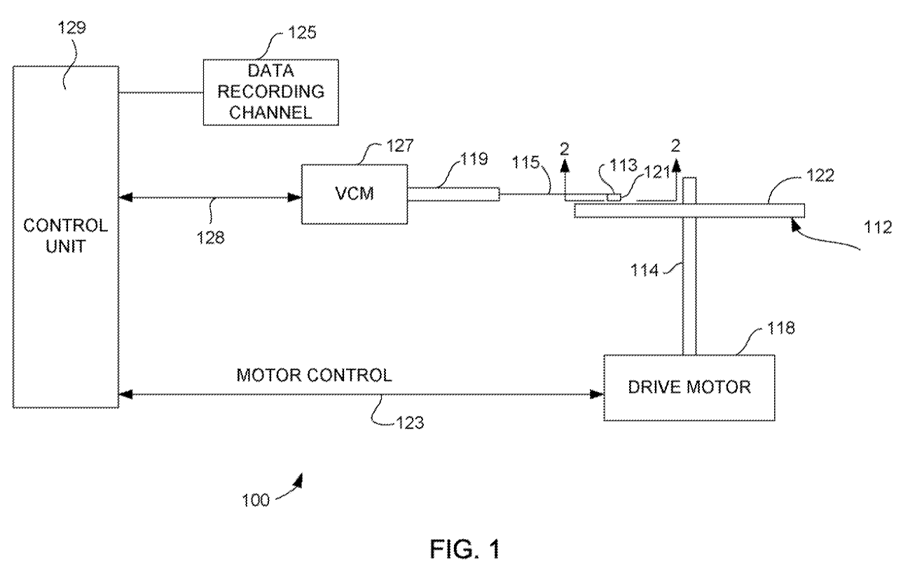

Referring now to FIG. 1, there is shown on a disk drive 100 embodying this invention. As shown in FIG. 1, at least one rotatable magnetic disk 112 is supported on a spindle 114 and rotated by a disk drive motor 118. The magnetic recording on each disk is in the form of annular patterns of concentric data tracks (not shown) on the magnetic disk 112.

At least one slider 113 is positioned near the magnetic disk 112, each slider 113 supporting one or more magnetic head assemblies 121. As the magnetic disk rotates, slider 113 moves radially in and out over the disk surface 122 so that the magnetic head assembly 121 may access different tracts of the magnetic disk where desired data are written. Each slider 113 is attached to an actuator arm 119 by way of a suspension 115. The suspension 115 provides a slight spring force which biases slider 113 against the disk surface 122. Each actuator arm 119 is attached to an actuator means 127. The actuator means 127 as shown in FIG. 1 may be a voice coil motor (VCM). The VCM comprises a coil movable within a fixed magnetic field, the direction and speed of the coil movements being controlled by the motor current signals supplied by controller 129.

During operation of the disk storage system, the rotation of the magnetic disk 112 generates an air bearing between the slider 113 and the disk surface 122 which exerts an upward force or lift on the slider. The air bearing thus counter-balances the slight spring force of suspension 115 and supports slider 113 off and slightly above the disk surface by a small, substantially constant spacing during normal operation.

The various components of the disk storage system are controlled in operation by control signals generated by control unit 129, such as access control signals and internal clock signals. Typically, the control unit 129 comprises logic control circuits, storage means and a microprocessor. The control unit 129 generates control signals to control various system operations such as drive motor control signals on line 123 and head position and seek control signals on line 128. The control signals on line 128 provide the desired current profiles to optimally move and position slider 113 to the desired data track on disk 112. Write and read signals are communicated to and from write and read heads 121 by way of recording channel 125. The above description of a typical magnetic disk storage system, and the accompanying illustration of FIG. 1 are for representation purposes only. It should be apparent that disk storage systems may contain a large number of disks and actuators, and each actuator may support a number of sliders.

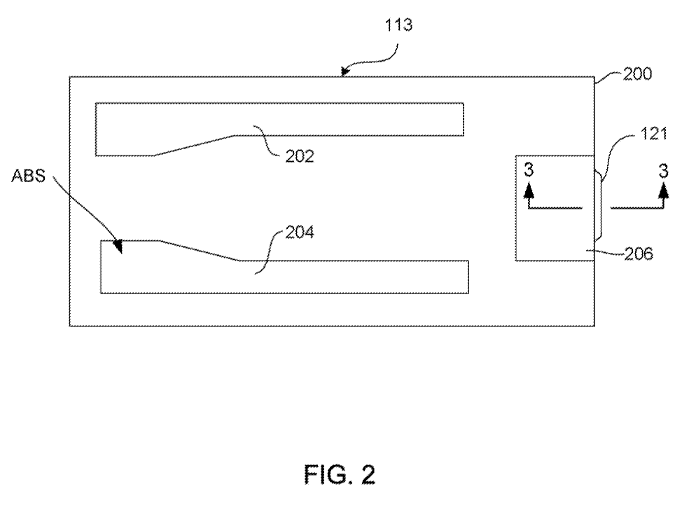

With reference to FIG. 2, the orientation of the magnetic head 121 in a slider 113 can be seen in more detail. FIG. 2 is an ABS view of the slider 113, and as can be seen the magnetic head including an inductive write head and a read sensor, is located at a trailing edge 200 of the slider. The slider has an air bearing surface (ABS) that can be configured with a topography that promotes a stable flight over a magnetic medium at a preferably very low fly height. For example, the ABS can be configured with side rails 202, 204 that are raised relative to the main surface. In addition, the ABS may include a raised pad 206 located near the trailing edge 200 of the slider 113.

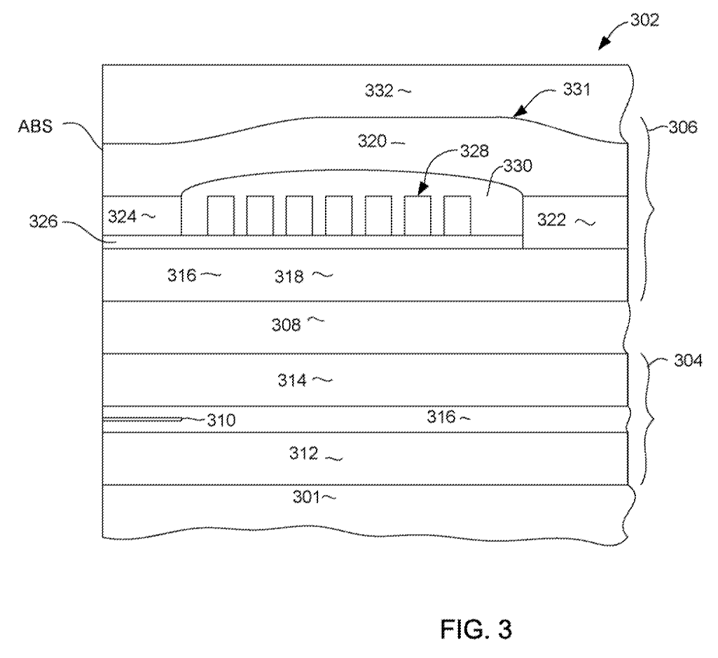

With reference now to FIG. 3, the invention can include a magnetic head 302, that includes a read head portion 304 and a write head portion 306 formed upon a substrate 301 that may be the slider body 113 (FIG. 2) or could be a dielectric layer formed over the slider body 113. The read head 304 and write head 306 can be separated from one another by a non-magnetic gap layer 308 such as alumina (Al₂O₃) or some other material. The read head portion 304 can include a magnetoresistive sensor 310 that can be sandwiched between first and second magnetic shields 312, 314 and embedded in a non-magnetic dielectric gap material 316. The write head portion 306 can include a bottom magnetic pole 318 and an upper pole 320 both of which are magnetically connected at a back gap portion 322 that is disposed away from an air bearing surface (ABS). A magnetic pedestal portion 324 may be provided near the ABS and magnetically connected with one of the top and bottom poles 318, 320 to define a pole tip portion of the write head 306. A non-magnetic write gap 326 magnetically separates the upper and lower poles 318, 320 (and as shown separates the pedestal 324 from the bottom pole 318) in order to provide a write gap for emitting a magnetic flux to an adjacent magnetic medium. An electrically conductive write coil 328 passes between the upper and lower poles 318, 320 to provide a magnetomotive force to induce a magnetic flux through the magnetic yoke 331 formed by the bottom pole 318, back gap 322, upper pole 320 and pedestal 324. The coil 328 is embedded in a non-magnetic, electrically insulating coil insulation layer 330. A protective layer 332, such as alumina, can be provided over the write head 306.

When current flows through the coil 328, a magnetic flux flows through the magnetic yoke 331. This causes a magnetic field to fringe out at the ABS across the write gap formed by the non-magnetic gap material 316. This fringing magnetic field can then write a magnetic signal onto an adjacent magnetic medium (not shown). This signal can be ready back by the magnetoresistive sensor 310, which can be a giant magnetoresistive sensor (GMR), tunnel junction sensor (TMR) or any other type of magnetoresistive sensor.

Although a particular embodiment of a magnetic head 302 has been shown and described above, this is only for purposes of illustrating an environment in which the present invention can be implemented. Virtually any type of read and write head can be employed in the present invention. For example, the write head could be designed for perpendicular magnetic recording and could include more than one write coil or could include a helical coil or a pancake coil.

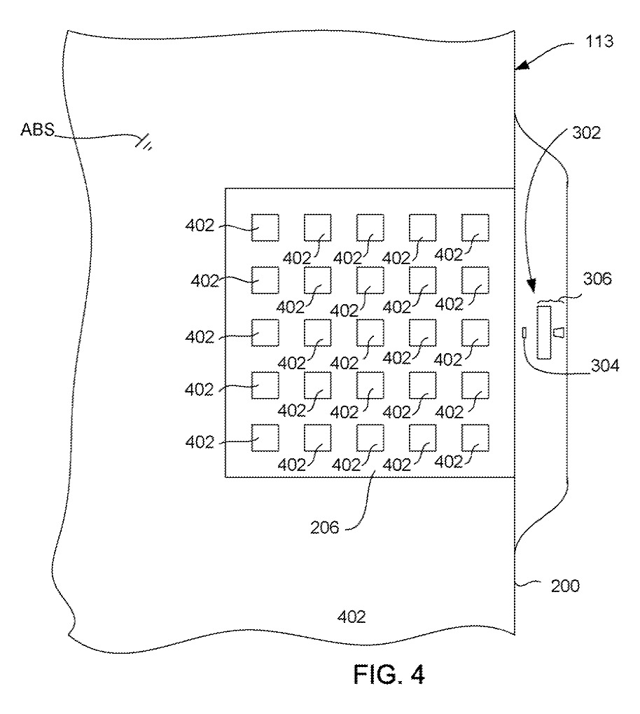

With reference now to FIG. 4, an enlarged view of the trailing edge of the slider 113 (discussed above with reference to FIG. 2) can be seen in greater detail. As discussed above, the ABS of the slider 113 includes a raised pad 206 that is raised relative to the surrounding portion of the ABS. The pad 206 causes a relatively higher pressure area to be formed at the trailing edge of the slider 113 (under the pad 206) during use when the slider is flying over a disk (not shown in FIG. 4).

As discussed above, magnetic recording systems have suffered from fly height oscillations when the slider is disturbed from its steady-state fly-height. At very low fly heights, the slider can begin to oscillate between high and low fly heights, causing the slider to actually bounce on the medium in the extreme case. This, of course leads to damaging head disk contact (crashing) which can result in data loss or, even worse, can lead to permanently damaging the read/write heads.

As can be seen, the pad 206 is configured with a pattern of recessed shapes 402. These recesses 402 are shown as squares in FIG. 4, but could be any shape or form of recesses. For example, the recesses 402 could be a pattern of groove or could be circular, triangular, irregular, or some other pattern. The recesses 402 can also be formed an unconnected depressions, or can be interconnected with one another. The recesses 402 create a series of localized pressure gradients within the generally high pressure area formed over the pad 206 between the pad 206 and the medium (not shown) during use. This series of pressure gradients provides a damping effect that prevents the undesirable oscillations described above. Therefore, the inclusion of the series of recesses 402 (recess pattern) prevents the undesirable slider bouncing that was discussed previously.

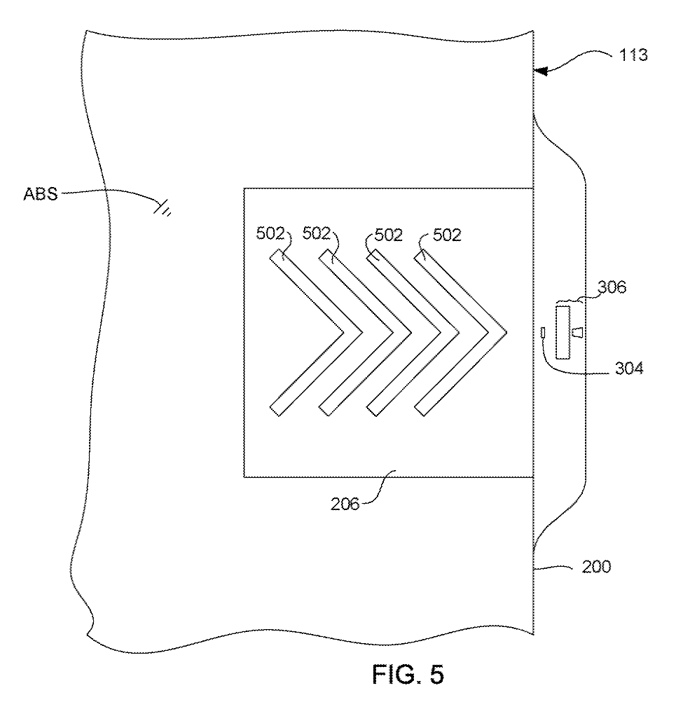

With reference to FIG. 5, the pad 206 could be configured with a pattern of recesses formed as grooves or trenches 402. Although these trenches 502 could be configured in any shape or orientation, they are preferably formed in a chevron pattern as shown. However, the trenches 502 could be formed in straight trenches oriented horizontally, vertically or in some other orientation or could be configured in a serpentine pattern, in an irregular pattern or in some other pattern. As with the recesses 402 described with reference to FIG. 4, the trenches 502 act to generate localized pressure gradients over the pad 206 when the slider 113 is flying over a disk.

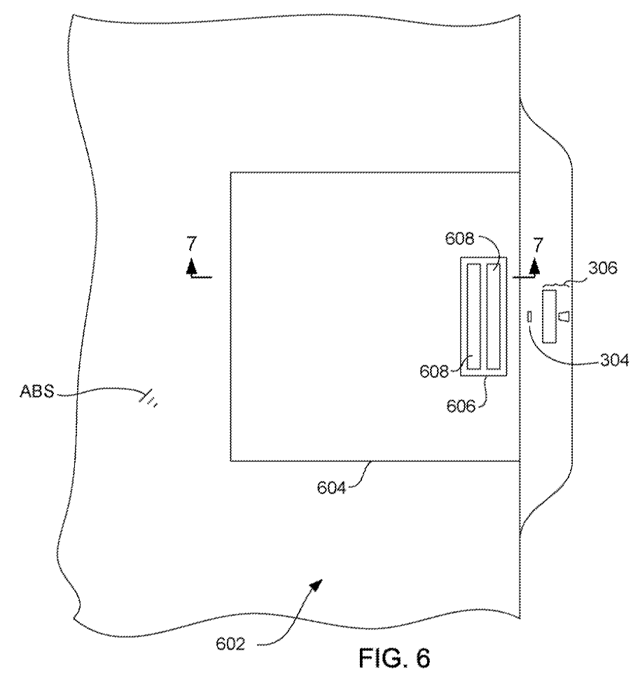

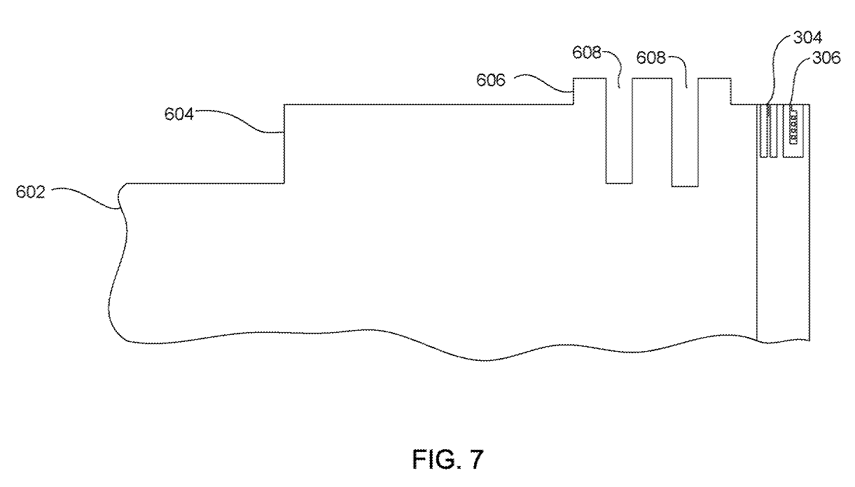

With reference to FIGS. 6 and 7, in another embodiment of the invention, a slider 602 can be configured with a primary pad 604 having a raised secondary pad 606. This secondary pad 606 can be a burnishing pad that is designed to be so close to the medium that is actually makes contact with the medium until either or both of the disk and secondary pad 606 have been sufficiently worn that they do not contact one another during use. Forming such a secondary pad over the trailing edge of the primary pad 604 can result in fly heights as low as 1-2 nm between the pad 606 and the medium during use.

Unfortunately, the pressure under the secondary pad becomes so great during burnishing or actual use that the problem of fly height oscillations is exacerbated by the use of such as secondary pad 606. Therefore, the localized pressure gradients and pressure relief provided by the present invention provides even greater advantage with use in slider 113 having such a secondary pad design.

In addition, slider bouncing during burnishing is particularly problematic. Since the slider is designed to be in contact with the disk at least at some point during burnishing, the bouncing of the slider 602 can cause even greater damage to the disk or read/write head. In addition, the uneven burnishing caused by the slider bouncing can cause unwanted ABS surface irregularities and can result in unwanted flying height changes.

To this end, as shown in FIG. 6, the secondary pad 606 is configured with a pattern of trenches 608. As with the previously described embodiments, the trenches 608 can be of any configuration, such as holes, chevrons or arbitrary shapes. As with the previously described embodiments, the recesses or trenches 608 provide localized pressure gradients over the generally high pressure area over the secondary pad 606. These localized pressure gradients provide a damping effect that prevents the slider from bouncing or oscillating over the surface of the disk. As mentioned above, the localized pressure gradients provided by the pattern of recesses 608 is especially important on a slider 602 having a secondary pad or burnishing pad 606.

While various embodiments have been described, it should be understood that they have been presented by way of example only, and not limitation. Other embodiments falling within the scope of the invention may also become apparent to those skilled in the art. Thus, the breadth and scope of the invention should not be limited by any of the above-described exemplary embodiments, but should be defined only in accordance with the following claims and their equivalents.

What is claimed is:

1. A slider for magnetic data a recording, comprising:
a slider body having an air bearing surface and having a trailing edge;
a magnetic read/write head formed on the trailing edge of the slider;
a raised pad formed on the air bearing surface the slider; and
a series of pressure relieving recesses formed on the raised pad.

2. A slider as in claim 1 wherein the slider is designed for flying over a magnetic disk and wherein the pressure relieving recesses create localized pressure gradients that damp slider oscillations when the slider is flying over the magnetic disk.

3. A magnetic slider as in claim 1 wherein the recesses are configured as series of unconnected depressions.

4. A magnetic slider as in claim 1 wherein the recesses are configured as square recesses.

5. A magnetic slider as in claim 1 the recesses are configured as round recesses.

6. A slider as in claim 1 wherein the recesses have an irregular shape.

7. A slider as in claim 1 wherein the recesses are configured as a series of trenches.

8. A slider as in claim 1 wherein the recesses are configured as a series of trenches oriented generally parallel with the trailing edge of the slider.

9. A slider as in claim 1 wherein the recesses are configured as a series of trenches oriented generally perpendicular to the trailing edge of the slider.

10. A slider as in claim 1 wherein the recesses are configured as a series of trenches forming an irregular shape.

11. A slider as in claim 1 wherein the recesses are configured as a series of trenches forming a chevron pattern.

12. A slider for magnetic data a recording, comprising:
a slider body having an air bearing surface and having a trailing edge;
a magnetic read/write head formed on the trailing edge of the slider;
a raised primary pad formed on the air bearing surface near the trailing edge of the slider and having a surface;
a raised secondary pad formed on the raised primary pad, the secondary pad having a surface that is raised relative to the surface of the raised primary pad and
a series of pressure relieving recesses formed on the raised pad.

13. A slider as in claim 12 wherein the primary pad has a trailing edge and wherein the trailing secondary pad is formed near the trailing edge of the primary pad.

14. A slider as in claim 12 wherein the slider is designed for flying over a magnetic disk and wherein the pressure relieving recesses create localized pressure gradients that damp slider oscillations when the slider is flying over the magnetic disk.

15. A magnetic slider as in claim 12 wherein the recesses are configured as series of unconnected depressions.

16. A magnetic slider as in claim 1 wherein the recesses are configured as square recesses.

17. A magnetic slider as in claim 12 the recesses are configured as round recesses.

18. A slider as in claim 12 wherein the recesses have an irregular shape.

19. A slider as in claim 12 wherein the recesses are configured as a series of trenches.

20. A slider as in claim 12 wherein the recesses are configured a series of trenches forming an irregular pattern.

21. A slider as in claim 12 wherein the recesses are configured as a series of trenches forming a chevron pattern.
